(19) United States
(12) Patent Application Publication
(10) Pub. No.: US 2006/0138936 A1
(43) Pub. Date: Jun. 29, 2006

(54) FED having polycrystalline silicon film emitters and method of fabricating polycrystalline silicon film emitters

(76) Inventors: Din-Guo Chen, Taipei City (TW); Jeng-Hung Sun, Hsin-Chu City (TW); Shyuan-Jeng Ho, Hsin-Chu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/305,633

(22) Filed: Dec. 16, 2005

Related U.S. Application Data
(60) Provisional application No. 60/636,552, filed on Dec. 17, 2004.

(51) Int. Cl. H01J 63/04; H01J 1/62

(52) U.S. Cl. 313/496

(57) ABSTRACT

An FED using polycrystalline silicon film emitters has a substrate divided into a plurality of pixel regions, a plurality of polycrystalline silicon film emitters disposed within the pixel regions of the substrate, a cathode layer disposed on the substrate, a faceplate disposed above the substrate, and an anode layer disposed between the substrate and the faceplate.

### CROSS REFERENCE TO RELATED APPLICATIONS

This application claims the benefit of U.S. Provisional Application No. 60/636,552 filed Dec. 17, 2004, and included herein by reference.

### BACKGROUND OF THE INVENTION

1. Field of the Invention

The present invention pertains to a field emission display (FED) and method of making the same.

2. Description of the Prior Art

In recent years, FED technology has come into favor as a technology for developing low power and flat panel displays. An FED normally includes a substrate (cathode plane), a faceplate (anode plate) disposed parallel to the substrate, and a narrow vacuum gap sandwiched in between the substrate and the faceplate. The FED can emit electrons at low microscopic electric fields (typically in the range of 1 to 20 V/μm) with sufficient current density (typically in the range of 10 to 100 mA/cm²) so as to generate bright fluorescence light from a phosphor layer disposed on the faceplate.

With reference to FIG. 1, FIG. 1 is a cross-sectional view schematically illustrating a conventional FED 10 with microtip emitters. As shown in FIG. 1, the conventional FED 10 includes a glass substrate 12, a glass faceplate 14 disposed above and parallel to the glass substrate 12, and spacers 16 disposed in between the glass substrate 12 and the glass faceplate 14 to maintain a gap therebetween. The glass substrate 12 includes a metal cathode layer 18 disposed on the glass substrate 12 facing the glass faceplate 14. The glass substrate 12 is divided into a plurality of pixel regions. On the metal cathode layer 18, a microtip emitter 20 made of Molybdenum is formed within each pixel region, and a gate electrode 22, insulated from the metal cathode layer 18 with an insulator 24, is disposed between two adjacent pixel regions.

The glass faceplate 14 includes a transparent anode layer 26 disposed on the glass faceplate 14 facing the glass substrate 12, black matrices 28 disposed on the anode layer 26 between adjacent pixel regions, and phosphor layers 30 disposed on the glass faceplate 14 within the pixel regions.

The microtip emitter 20 is adopted because the sharp point concentrates the electric field and allows electrons to tunnel out of the conduction band and emit into the vacuum. Although the microtip structure 20 is able to generate high current densities, the microtip emitter 20 is susceptible to thermal damage due to resistive heating, physical sputter damage due to residual gases in the surrounding vacuum environment, and surface chemical modification from incident species. In addition, the microtip construction has the disadvantages of high cost due to complicated process, limitations in display size, poor reliability, and high voltage required for the emitting process.

In the past few years, a film emitter has been used as electron emitter of an FED. This film type emitter eases the lithography process in fabrication of an FED. Many thin film materials such as amorphous silicon, amorphous carbon and diamond have been tested as candidates for emitter materials, however, they all suffer from insurmountable limitations to produce low cost, large size and manufacture-ready FED. Recently, carbon nanotube (CNT) has been selected as emitter's material, and an FED having CNT emitter possesses superior field emission performance. Nevertheless, mass production of CNT has posed a problem, particularly to produce CNT with consistent size and microstructure. This variation causes the luminance non-uniformity and inconsistency problems in a CNTFED, especially for the low temperature processes that is required for a large size display using a glass substrate. Another problem of the CNTFED is the sensitivity of its electron properties to common gases, such as oxygen, in its immediate environment.

Except for the aforementioned problems, the CNT tends to grow close together, and the effect of their high aspect ratio that lowers the threshold field for emission is significantly reduced. Some growth control technologies using dispersed patches of catalyst or template were developed to grow the CNT at more regular distances for reducing this shielding effect. However, these technologies still have limited manufacturability.

### SUMMARY OF THE INVENTION

It is one object of the present invention to provide an FED having polycrystalline silicon film emitters and a method of fabricating polycrystalline silicon film emitters of an FED to improve field emission characteristic.

According to the claimed invention, an FED having polycrystalline silicon film emitters is provided. The FED includes a substrate divided into a plurality of pixel regions, a plurality of polycrystalline silicon film emitters, each polycrystalline silicon emitter being disposed within each pixel region of the substrate, a cathode layer disposed on the substrate, a faceplate disposed above the substrate, wherein the polycrystalline silicon film emitters and the cathode layer disposed between the substrate and the faceplate, and an anode layer disposed between the substrate and the faceplate.

According to the claimed invention, a method of fabricating polycrystalline silicon film emitters of an FED is provided. First, a substrate of the FED is provided. Subsequently, an amorphous silicon film is formed on the substrate, and the amorphous silicon film is recrystallized into a polycrystalline silicon film. Following that, the polycrystalline silicon film is patterned to from a plurality of polycrystalline silicon film emitters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view schematically illustrating a conventional FED 10 with microtip emitters.

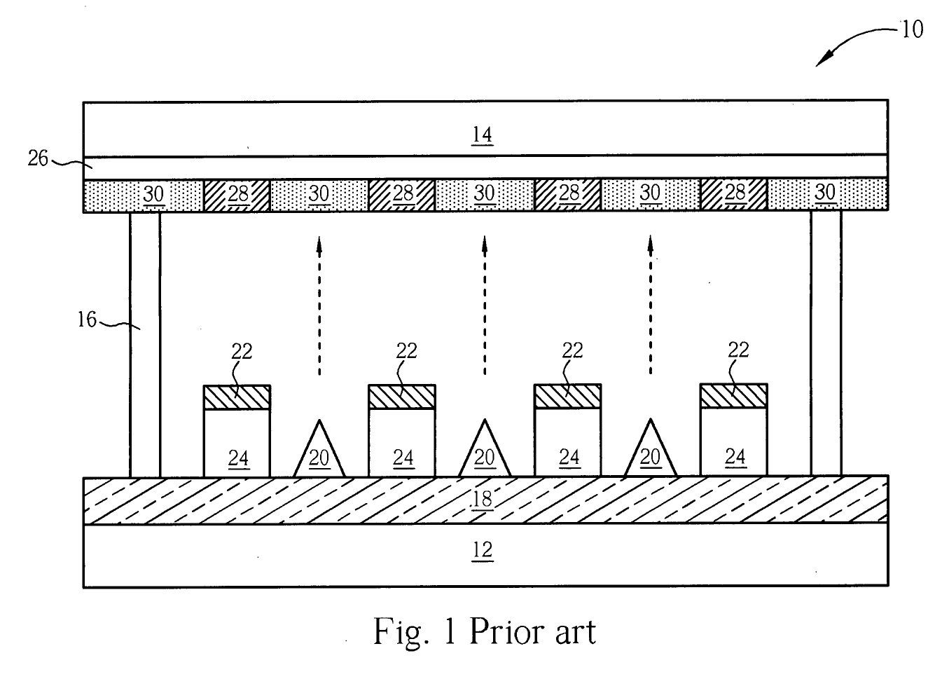

FIG. 2 is a schematic diagram of a triode type FED using polycrystalline silicon film emitters in accordance with a first embodiment of the present invention.

FIG. 3 is an emission current vs. electric field relation chart of the polycrystalline silicon film emitter.

FIG. 4 is a schematic diagram of a buried gate triode type FED using polycrystalline silicon film emitters in accordance with a second embodiment of the present invention.

FIG. 5 is a schematic diagram of a remote gate triode type FED using polycrystalline silicon film emitters in accordance with a third embodiment of the present invention.

FIG. 6 is a schematic diagram of a tetrode type FED using polycrystalline silicon film emitters in accordance with a fourth embodiment of the present invention.

FIG. 7 is a schematic diagram of an integral edge emitting type FED using polycrystalline silicon film emitters in accordance with a fifth embodiment of the present invention.

FIG. 8 is a schematic diagram of a surface emitting type FED using polycrystalline silicon film emitters in accordance with a sixth embodiment of the present invention.

FIG. 9 is a schematic diagram of a focusing spacer type FED using polycrystalline silicon film emitters in accordance with a seventh embodiment of the present invention.

FIG. 10 is a function block diagram illustrating an electronic apparatus having an FED incorporated therein in accordance with another embodiment of the present invention.

FIG. 11 is a flow chart illustrating a method of fabricating polycrystalline silicon film emitters of an FED according to the present invention.

FIG. 12 is a chart illustrating an average height of the polycrystalline silicon film emitters of the present invention.

### DETAILED DESCRIPTION

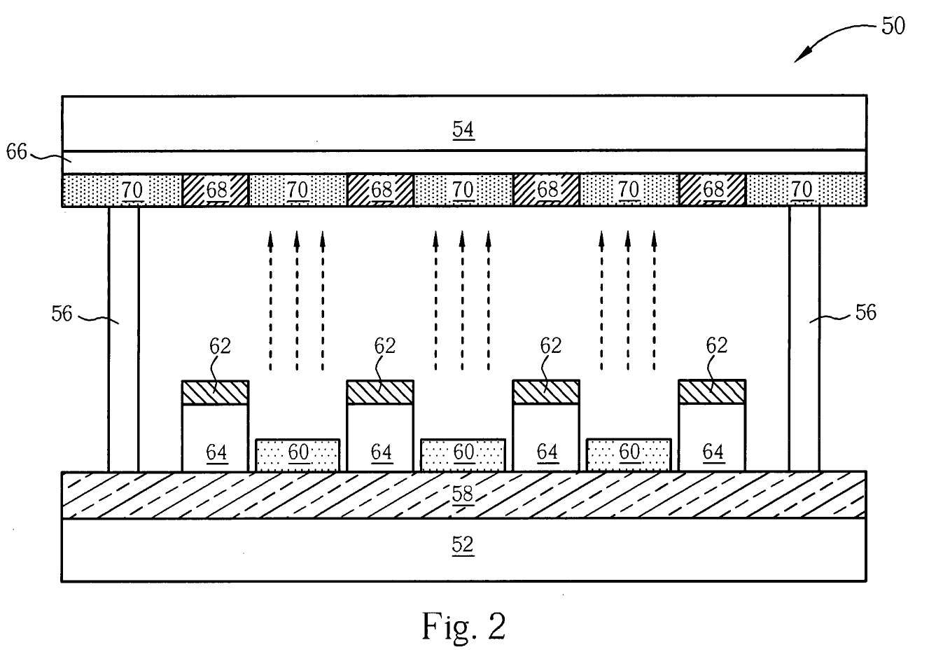

The present invention is hereinafter explained in more detail by embodiments, where like components are denoted by like numerals. Referring to FIG. 2, FIG. 2 is a schematic diagram of a triode type FED using polycrystalline silicon film emitters in accordance with a first embodiment of the present invention. As shown in FIG. 2, the FED 50 includes a substrate 52 e.g. a glass substrate, a faceplate 54, e.g. a glass faceplate, disposed above and parallel to the substrate 52, and spacers 56 disposed in between the substrate 52 and the faceplate 54 to maintain a vacuum gap therebetween. The substrate 52 includes a cathode layer 58 made of metal disposed on the substrate 52 facing the faceplate 54. The glass substrate 52 can be divided into a plurality of pixel regions. On the cathode layer 58, polycrystalline silicon film emitter 60 is formed within each pixel region, and gate electrodes 62, insulated from the cathode layer 58 with an insulator 64, is disposed between two adjacent pixel regions.

The faceplate 54 includes a transparent anode layer 66 such as an ITO layer disposed on the faceplate 54 facing the substrate 52, black matrices 68 disposed on the anode layer 66 between adjacent pixel regions, and phosphor layers 70 disposed on the faceplate 54 within the pixel regions.

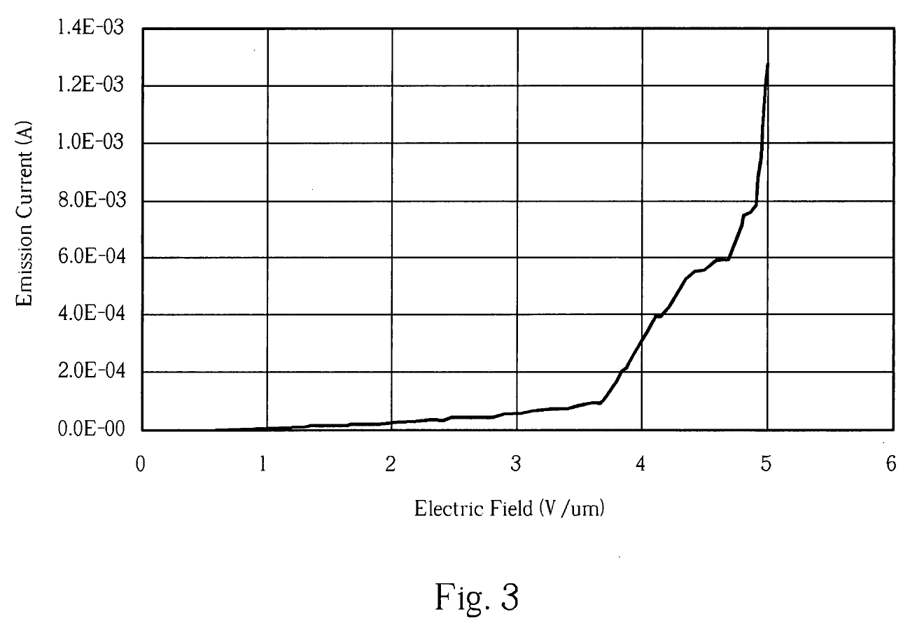

With reference to FIG. 3, FIG. 3 is an emission current vs. electric field relation chart of the polycrystalline silicon film emitter. As shown in FIG. 3, the threshold electric field of the polycrystalline silicon film emitters reaches approximately 3.75V/μm on a large size substrate e.g. a 620*750 mm substrate. Since the field emission threshold of emitter is strongly dependent on the geometric characteristic of the emitter, the threshold electric field shows the uniformity of the polycrystalline silicon film emitter.

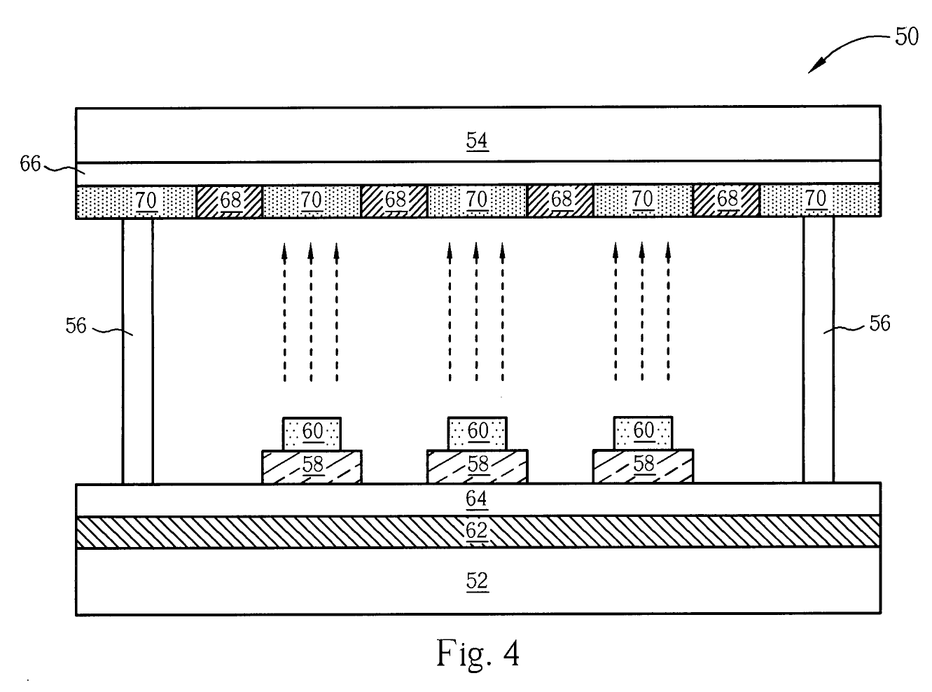

Referring to FIG. 4, FIG. 4 is a schematic diagram of a buried gate triode type FED using polycrystalline silicon film emitters in accordance with a second embodiment of the present invention. As shown in FIG. 4, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a gate electrode 62, made of metal for example, disposed on the substrate 52 facing the faceplate 54, and an insulator 64 disposed on the gate electrode 62. On the insulator 64 lies a cathode layer 58 including a plurality of cathodes, and a plurality of polycrystalline silicon film emitters 60 are disposed on the cathode layer 58 within the pixel regions.

The faceplate 54 includes a transparent anode layer 66 such as an ITO layer disposed on the faceplate 54 facing the substrate 52, black matrices 68 disposed on the anode layer 66 between adjacent pixel regions, and phosphor layers 70 disposed on the faceplate 54 within the pixel regions.

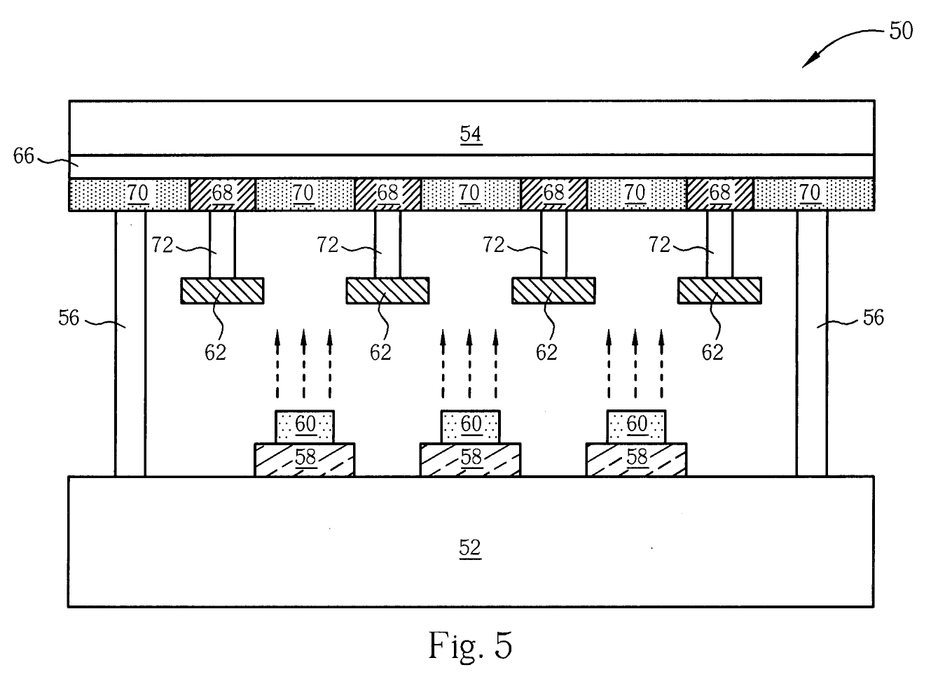

Referring to FIG. 5, FIG. 5 is a schematic diagram of a remote gate triode type FED using polycrystalline silicon film emitters in accordance with a third embodiment of the present invention. As shown in FIG. 5, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a cathode layer 58 including a plurality of cathodes disposed on the substrate 52, and polycrystalline silicon film emitters 60 disposed on the cathode layer 58.

The faceplate 54 includes a transparent anode layer 66 such as an ITO layer disposed on the faceplate 54 facing the substrate 52, black matrices 68 disposed on the anode layer 66 between adjacent pixel regions, phosphor layers 70 disposed on the faceplate 54 within the pixel regions, and gate electrodes 62 suspended from the black matrices 68 with support structures 72.

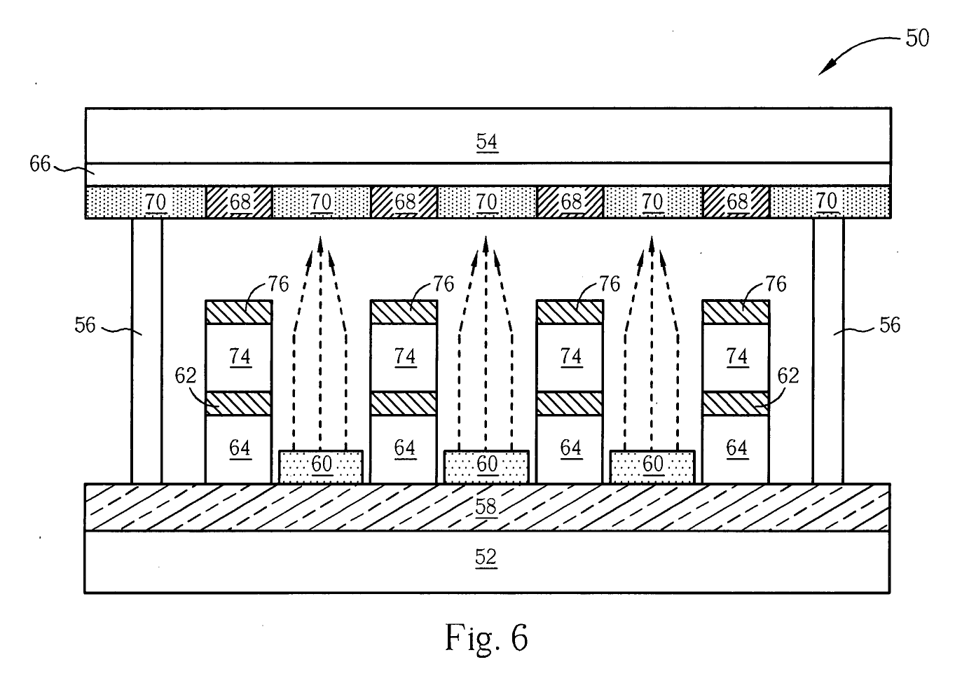

Referring to FIG. 6, FIG. 6 is a schematic diagram of a tetrode type FED using polycrystalline silicon film emitters in accordance with a fourth embodiment of the present invention. As shown in FIG. 6, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a cathode layer 58 disposed on the substrate 52 facing the faceplate 54, insulators 64 disposed on the cathode layer 58, gate electrodes 62 disposed on the insulators 64, another insulators 74 stacked on the gate electrodes 62, and focusing electrodes 76 disposed on the insulators 74 between two adjacent pixel regions. The polycrystalline silicon film emitters 60 are positioned on the cathode layer 58 within the pixel regions.

The faceplate 54 includes a transparent anode layer 66 such as an ITO layer disposed on the faceplate 54 facing the substrate 52, black matrices 68 disposed on the anode layer 66 between adjacent pixel regions, and phosphor layers 70 disposed on the faceplate 54 within the pixel regions.

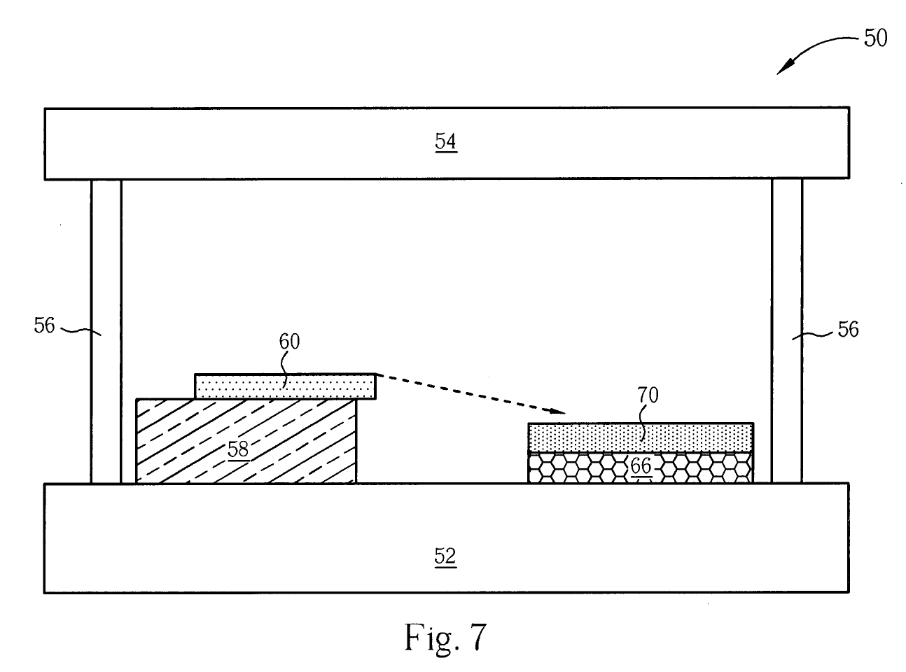

Referring to FIG. 7, FIG. 7 is a schematic diagram of an integral edge emitting type FED using polycrystalline silicon film emitters in accordance with a fifth embodiment of the present invention. As shown in FIG. 7, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a cathode layer 58 and an anode layer 66 both disposed on the substrate 52. The polycrystalline silicon film emitters 60 are formed on the cathode layer 58, and each polycrystalline silicon film emitter 60 and each cathode are partially overlapping. The phosphor layers 70 are positioned on the anode layer 66. It is appreciated that the anode layer 66 in this embodiment is not necessary to be transparent since it is located on the substrate 52.

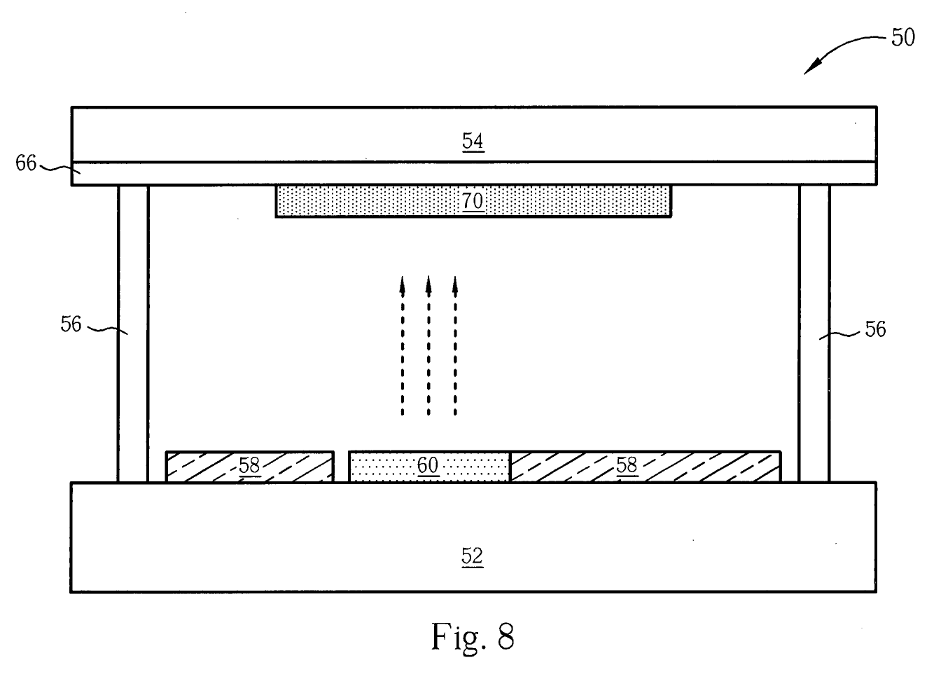

With reference to FIG. 8, FIG. 8 is a schematic diagram of a surface emitting type FED using polycrystalline silicon film emitters in accordance with a sixth embodiment of the present invention. As shown in FIG. 8, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a cathode layer 58 having a plurality of cathodes disposed on the substrate 52, and polycrystalline silicon film emitters 60 positioned on the same plane as the cathode layer 58.

The faceplate 54 includes a transparent anode layer 66 such as an ITO layer disposed on the faceplate 54 facing the substrate 52, and phosphor layers 70 disposed on the anode layer 66 corresponding to the polycrystalline silicon film emitters 60.

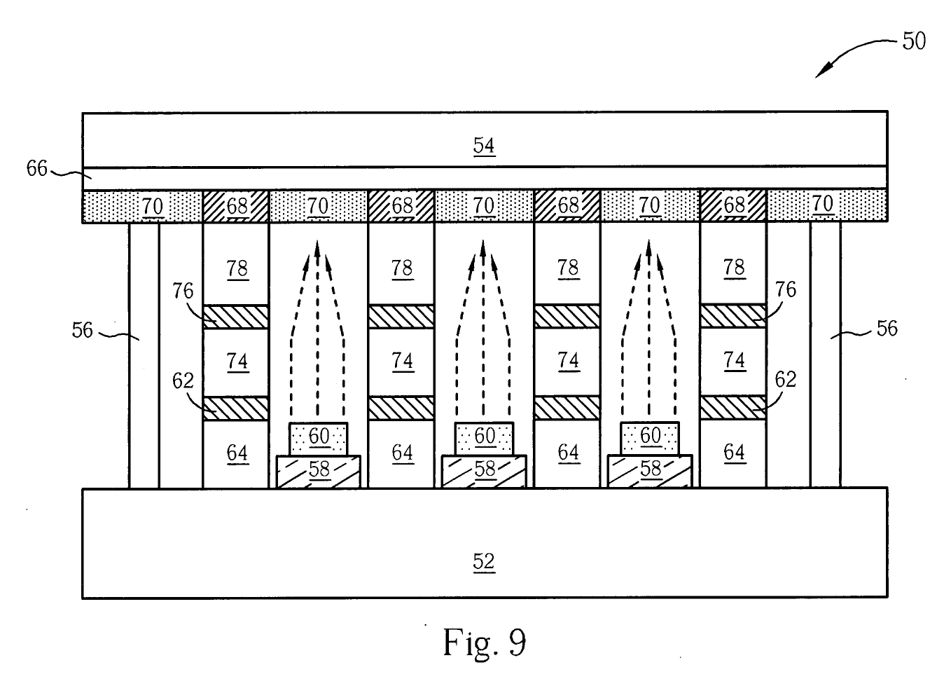

Referring to FIG. 9, FIG. 9 is a schematic diagram of a focusing spacer type FED using polycrystalline silicon film emitters in accordance with a seventh embodiment of the present invention. As shown in FIG. 9, the FED 50 includes a substrate 52, a faceplate 54 disposed above and parallel to the substrate 52, and spacers 56 disposed in between the substrate 52 and the faceplate 54 to maintain a gap therebetween. The substrate 52 includes a cathode layer 58 having a plurality of cathodes disposed on the substrate 52 within the pixel regions, polycrystalline silicon film emitters 60 positioned on the cathode layer 58 within the pixel regions, insulators 64 disposed on the substrate 52 between two adjacent pixel regions, gate electrodes 62 disposed on the insulators 64, another insulators 74 stacked on the gate electrode 62, focusing electrodes 76 disposed on the insulators 74, and another spacers 78 disposed on the focusing electrodes 76. The substrate 52 further includes.

The faceplate 54 includes a transparent anode layer 66 such as an ITO layer disposed on the faceplate 54 facing the substrate 52, black matrices 68 disposed on the anode layer 66 between adjacent pixel regions, and phosphor layers 70 disposed on the faceplate 54 within the pixel regions. It is appreciated that the spacers 78 couple to the black matrices 68 of the faceplate 54, and thus can support the faceplate 54 and maintain the gap between the substrate 52 and the faceplate 54.

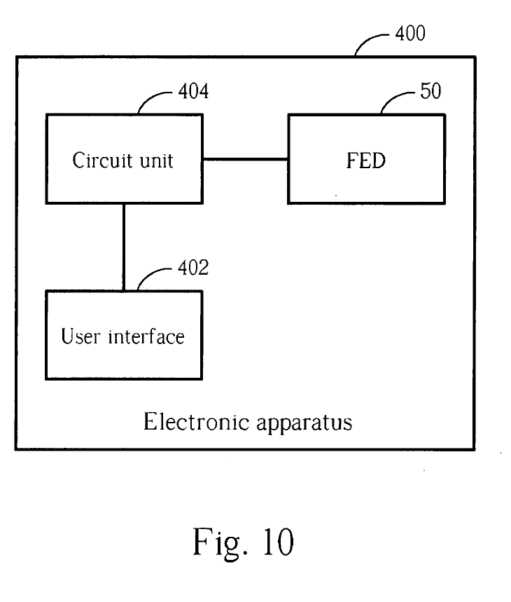

Please refer to FIG. 10. FIG. 10 is a function block diagram illustrating an electronic apparatus 400 having the FED 50 incorporated therein in accordance with another embodiment of the present invention. As shown in FIG. 10, the electronic apparatus 400 includes an FED 50, a circuit unit 404 coupled to the FED 50, and a user interface 402 coupled to the circuit unit 404. The FED 50 can be any type of field emission display illustrated in the aforementioned embodiments.

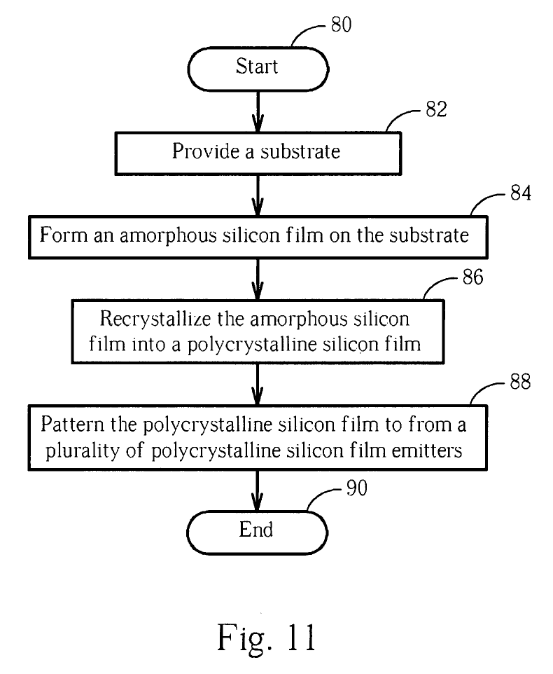

Please refer to FIG. 11. FIG. 11 is a flow chart illustrating a method of fabricating polycrystalline silicon film emitters of an FED according to the present invention. As shown in FIG. 11, the method of the present invention includes the steps as follows:

Step 80: start;

Step 82: provide a substrate;

Step 84: form an amorphous silicon film on the substrate;

Step 86: recrystallize the amorphous silicon film into a polycrystalline silicon film;

Step 88: pattern the polycrystalline silicon film to from a plurality of polycrystalline silicon film emitters; and

Step 90: end.

In this embodiment, the amorphous silicon film is formed by CVD, APCVD, LPCVD, ICPCVD, ECRCVD, sputtering or other deposition techniques. The recrystallization can be implemented by excimer laser annealing (ELA), selective lateral solidification (SLS) or other techniques. The polycrystalline silicon film emitter has a thickness substantially ranging from 20 to 500 nanometers, and a grain size substantially ranging from 2000 to 5500 angstroms.

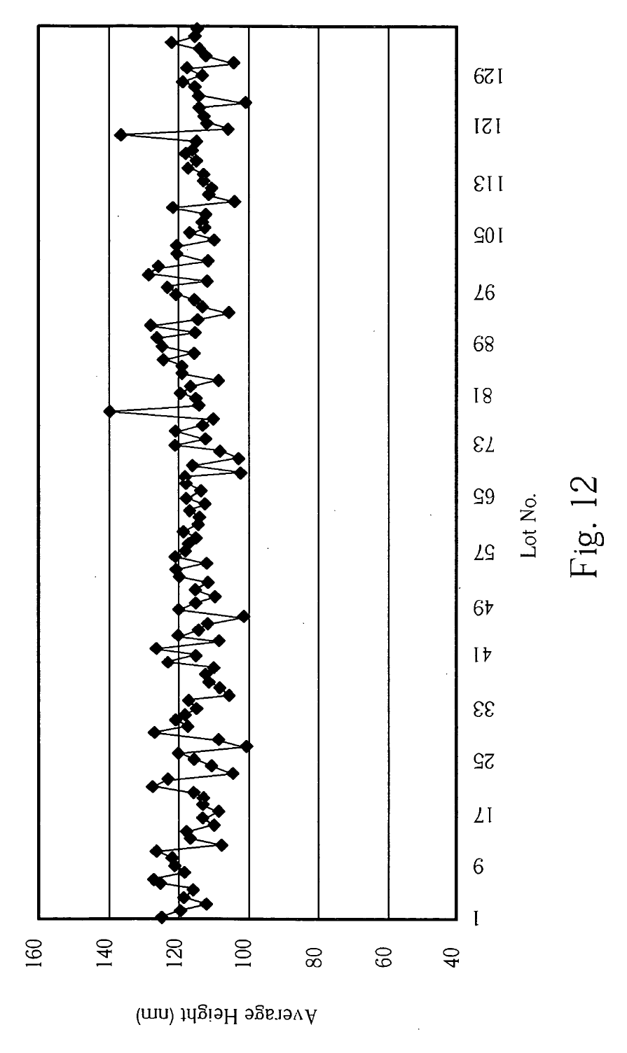

Referring to FIG. 12, FIG. 12 is a chart illustrating an average height of the polycrystalline silicon film emitters of the present invention. The average height data of the polycrystalline silicon film emitters is obtained by measuring six positions across a 620*730 mm substrate using an AFM. As shown in FIG. 12, the average height data demonstrates the consistency and uniformity of the polycrystalline silicon film emitters fabricated by the method of the present invention.

The method of the present invention features forming polycrystalline silicon film emitters by virtue of recrystallizing amorphous silicon into polycrystalline silicon in low temperature. The LTPS film emitters, which can be realized in large size glass substrate, have the advantage of uniformity and consistency. Therefore, the emission characteristic of the FED is improved.

In summary, the FED using polycrystalline silicon film emitters and the method of making the same has the following advantages.
1) The polycrystalline silicon film emitter can be large area for FED application.
2) The field emission characteristic is significantly improved.
3) The geometric structure and density of the polycrystalline silicon film emitter is controllable by adjusting the fabricating process.
4) The consistency of the polycrystalline silicon film emitter is better.
5) The polycrystalline silicon film emitter can be applied to various type of FED.
6) The driving of the FED can be either active matrix or passive matrix.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A field emission display (FED) having polycrystalline silicon film emitters, comprising:
a substrate divided into a plurality of pixel regions;
a plurality of polycrystalline silicon film emitters, each polycrystalline silicon emitter being disposed within each pixel region of the substrate;
a cathode layer disposed on the substrate;
a faceplate disposed above the substrate, wherein the polycrystalline film emitters and the cathode layer disposed between the substrate and the faceplate; and
an anode layer disposed between the substrate and the faceplate.

2. The FED of claim 1, wherein the polycrystalline silicon film emitters are low temperature polycrystalline silicon (LTPS) emitters.

3. The FED of claim 1, wherein the polycrystalline silicon film emitters are disposed on the cathode layer.

4. The FED of claim 1, wherein the cathode layer comprises a plurality of cathodes corresponding to the polycrystalline silicon film emitters.

5. The FED of claim 4, wherein each polycrystalline silicon emitter is disposed on each cathode.

6. The FED of claim 5, wherein each polycrystalline silicon emitter and each cathode are partially overlapping.

7. The FED of claim 4, wherein the polycrystalline silicon film emitters and the cathodes are disposed on a same level.

8. The FED of claim 1, wherein the anode layer is disposed on the faceplate.

9. The FED of claim 1, wherein the anode layer comprises a plurality of anodes disposed on the substrate, and each anode is disposed within each pixel region.

10. The FED of claim 9, further comprising a plurality of phosphor patterns, and each phosphor pattern is disposed on each anode.

11. The FED of claim 1, further comprising a gate electrode layer insulated from the cathode layer.

12. The FED of claim 11, wherein the gate electrode layer is disposed between the substrate and the cathode layer.

13. The FED of claim 111, wherein the gate electrode layer comprises a plurality of gate electrodes, and each gate electrode is disposed between any two adjacent pixel regions.

14. The FED of claim 13, wherein the gate electrodes are disposed on the cathode layer.

15. The FED of claim 14, further comprising a plurality of focusing electrodes stacked on the gate electrodes, and each focusing electrode is insulated from each gate electrode.

16. The FED of claim 15, further comprising a plurality of spacers, and each spacer is sandwiched in between each focusing electrode and the faceplate.

17. The FED of claim 13, wherein the gate electrodes are disposed on the faceplate.

18. The FED of claim 1, further comprising a plurality of spacers sandwiched in between the faceplate and the substrate.

19. The FED of claim 1, wherein the polycrystalline silicon film emitters have a thickness substantially ranging from 20 to 500 nanometers.

20. The FED of claim 1, wherein the polycrystalline silicon film emitters have a grain size substantially ranging from 2000 to 5500 angstroms.

21. An electronic apparatus, comprising:
an flat panel display as claimed in claim 1
a circuit unit coupled to the flat panel display; and
a user interface coupled to the circuit unit.
